(19) United States
(12) Patent Application Publication
(10) Pub. No.: US 2020/0407581 A1
(43) Pub. Date: Dec. 31, 2020

(54) OPTICAL SHAPING INK SET, OPTICALLY SHAPED ARTICLE, AND METHOD FOR PRODUCING OPTICALLY SHAPED ARTICLE

(71) Applicant: Maxell Holdings, Ltd., Kyoto (JP)

(72) Inventors: Katsuyuki KITO, Kyoto (JP); Taeko IZUMO, Kyoto (JP)

(21) Appl. No.: 16/476,712

(22) PCT Filed: Jan. 31, 2018
(86) PCT No.: PCT/JP2018/003300

§ 371 Date: Jul. 9, 2019

(30) Foreign Application Priority Data
Jan. 31, 2017 (JP) 2017-016121

(51) Int. Cl. C09D 11/40; C09D 11/38; C09D 11/102; C09D 11/033; C09D 11/101; B29C 64/112; B29C 64/40; B33Y 10/00; B33Y 70/10; B29C 64/124

(52) U.S. Cl. CPC C09D 11/40; C09D 11/38; C09D 11/102; C09D 11/033; C09D 11/101; B29K 2075/00; B29C 64/40; B33Y 10/00; B33Y 70/10; B29C 64/124; B29C 64/112

(57) ABSTRACT

In an optical shaping ink set, a composition for model material contains a monofunctional ethylenically unsaturated monomer (A) at 50 to 90 parts by weight, a polyfunctional ethylenically unsaturated monomer (B) which does not contain a urethane group at 3 to 25 parts by weight, a urethane group-containing ethylenically unsaturated monomer (C) at 5 to 35 parts by weight, and a photopolymerization initiator (D) at 0.1 to 10 parts by weight, and the composition for support material contains a water-soluble monofunctional ethylenically unsaturated monomer (a) at 20 to 50 parts by weight, a polyalkylene glycol (b) containing EO and/or PO at 20 to 49 parts by weight, a water-soluble organic solvent (c) at 35 parts by weight or less, and a photopolymerization initiator (d).

### TECHNICAL FIELD

The present application is filed, claiming the Paris Convention priorities based on the Japanese Patent Application No. 2017-016121 (filing date: Jan. 31, 2017), and a whole of the contents of these applications is incorporated herein by reference.

The present invention relates to an optical shaping ink set (an ink set for stereolithography) used in an inkjet optical shaping method (inkjet stereolithography), an optically shaped article shaped using the optical shaping ink set, and a method for producing an optically shaped article (a stereolithographic article) using the optical shaping ink set.

### BACKGROUND ART

Conventionally, as a method for producing a three-dimensional shaped object, a shaping method using a photocurable composition that is cured by being irradiated with ultraviolet light and the like has been widely known. Specifically, in such a shaping method, a photocurable composition is irradiated with ultraviolet light and thus cured to form a cured layer having a predetermined shape. Thereafter, a photocurable composition is further supplied onto the cured layer and cured to form a new cured layer. The above-mentioned steps are repeatedly performed to obtain a three-dimensional shaped object.

Among the above-mentioned shaping methods, in recent years there has been reported an inkjet optical shaping method in which a photocurable composition is discharged from a nozzle, irradiated with ultraviolet light and the like immediately thereafter, and thus cured to form a cured layer having a predetermined shape (hereinafter referred to as inkjet optical shaping method) (Patent Documents 1 to 4). The inkjet optical shaping method does not require the installation of a large resin liquid tank for storing the photocurable composition and a dark room. For this reason, the shaping apparatus can be further miniaturized as compared with that in the conventional method. The inkjet optical shaping method has attracted attention as a shaping method to be realized by a 3D printer which can freely make a three-dimensional shaped object based on CAD (Computer Aided Design) data.

In the inkjet optical shaping method, in the case of shaping an optically shaped article having a complicated shape such as a hollow shape, the optically shaped article is formed by using a model material in combination with a support material in order to support the model material (Patent Documents 1, 2, and 4). The support material is formed by irradiating a photocurable composition with ultraviolet light and the like and thus curing the photocurable composition in the same manner as the forming of model material. After forming the model material, the support material can be removed by being physically peeled off or dissolved in an organic solvent or water.

Further, Patent Document 4 discloses a composition for model material in which deformation due to water swelling or moisture absorption at the time of photocuring and after curing is extremely minor, a composition for support material of which the cured product after curing exhibits excellent solubility in water and is easily removed, and an optically shaped article shaped using these compositions by an inkjet optical shaping method.

### PRIOR ART DOCUMENT

### Patent Documents

Patent Document 1: JP-A-2004-255839
Patent Document 2: JP-A-2010-155889
Patent Document 3: JP-A-2010-155926
Patent Document 4: JP-A-2012-111226
Patent Document 5: JP-A-2015-107653

### SUMMARY OF THE INVENTION

### Problems to be Solved by the Invention

In the composition for model material disclosed in Patent Document 4, a model material to be extremely slightly deformed by swelling is obtained by photocuring the composition for model material. It is possible to shape an optically shaped article having good dimensional accuracy when such a composition for model material is used.

Meanwhile, the composition for support material disclosed in Patent Document 4 comprises a large amount of nonpolymerizable components which are not photocured. For this reason, a gel-like support material is obtained by photocuring the composition for support material. The support material can be easily removed, for example, by being physically peeled off. However, such a support material is inferior in self-standing ability. For this reason, in order to shape an optically shaped article having good dimensional accuracy by use of the composition for model material disclosed in Patent Document 4, it is required to use a wall and the like for supporting the support material, for example, as disclosed in Patent Document 5. There is a problem of being inferior in workability when such a wall and the like are made.

The present invention has been made in view of the present situation, and an object thereof is to provide an optical shaping ink set for obtaining an optically shaped article having good dimensional accuracy by using a support material exhibiting excellent self-standing ability, an optically shaped article shaped using the optical shaping ink set, and a method for producing an optically shaped article in which the optical shaping ink set is used and the workability is excellent.

### Solutions to the Problems

The present inventors have found out that a support material exhibiting excellent self-standing ability is obtained by regulating the content of a nonpolymerizable component and the content of a water-soluble monofunctional ethylenically unsaturated monomer in a composition for support material in predetermined ranges. The present inventors have found out that it is possible to shape an optically shaped article having good dimensional accuracy by using the composition for support material and a composition for model material from which a model material to be extremely slightly deformed by swelling can be obtained.

The present invention has been achieved based on the above findings, and the gist thereof is as follows.

(1) An optical shaping ink set, which is used in an inkjet optical shaping method, comprising a composition for model material used for shaping a model material in combination with a composition for support material used for shaping a support material,

wherein

the composition for model material contains, with respect to 100 parts by weight of the total amount of the composition for model material,
a monofunctional ethylenically unsaturated monomer (A) at 50 to 90 parts by weight,
a polyfunctional ethylenically unsaturated monomer (B) which does not contain a urethane group at 3 to 25 parts by weight,
a urethane group-containing ethylenically unsaturated monomer (C) at 5 to 35 parts by weight, and
a photopolymerization initiator (D) at 0.1 to 10 parts by weight, and

the composition for support material contains, with respect to 100 parts by weight of the total amount of the composition for support material,
a water-soluble monofunctional ethylenically unsaturated monomer (a) at 20 to 50 parts by weight,
a polyalkylene glycol (b) containing an oxyethylene group and/or an oxypropylene group at 20 to 49 parts by weight,
a water-soluble organic solvent (c) at 35 parts by weight or less, and
a photopolymerization initiator (d).

(2) The optical shaping ink set according to (1), wherein the composition for model material has a weighted average value of an SP value of 9.0 to 10.3.

(3) The optical shaping ink set according to (1) or (2), wherein a content of a water-soluble component in the composition for model material is 10 parts by weight or less with respect to 100 parts by weight of the total amount of the composition for model material.

(4) The optical shaping ink set according to any one of (1) to (3), wherein a water swelling rate of a model material obtained by photocuring the composition for model material is 1% by weight or less.

(5) The optical shaping ink set according to any one of (1) to (4), wherein a glass transition point of a model material obtained by photocuring the composition for model material is 50° C. to 120° C.

(6) The optical shaping ink set according to any one of (1) to (5), wherein a content of the water-soluble monofunctional ethylenically unsaturated monomer (a) in the composition for support material is 25 to 45 parts by weight with respect to 100 parts by weight of the total amount of the composition for support material.

(7) The optical shaping ink set according to any one of (1) to (6), wherein a content of the polyalkylene glycol (b) in the composition for support material is 25 to 45 parts by weight with respect to 100 parts by weight of the total amount of the composition for support material.

(8) The optical shaping ink set according to any one of (1) to (7), wherein a content of the water-soluble organic solvent (c) in the composition for support material is 5 parts by weight or more with respect to 100 parts by weight of the total amount of the composition for support material.

(9) The optical shaping ink set according to any one of (1) to (8), wherein a content of the photopolymerization initiator (d) in the composition for support material is 1 to 25 parts by weight with respect to 100 parts by weight of the total amount of the composition for support material.

(10) The optical shaping ink set according to any one of (1) to (9), wherein the composition for support material further contains a storage stabilizer (e) at 0.05 to 3.0 parts by weight with respect to 100 parts by weight of the total amount of the composition for support material.

(11) An optically shaped article shaped by an inkjet optical shaping method using the optical shaping ink set according to any one of (1) to (10).

(12) A method for producing an optically shaped article by an inkjet optical shaping method using the optical shaping ink set according to any one of (1) to (10), the method comprising:

a step (I) of photocuring the composition for model material to obtain a model material and, at the same time, photocuring the composition for support material to obtain a support material; and

a step (II) of removing the support material.

(13) The method for producing an optically shaped article according to (12), wherein the composition for model material and the composition for support material are photocured using an ultraviolet LED in the step (I).

### Effects of the Invention

According to the present invention, it is possible to provide an optical shaping ink set for obtaining an optically shaped article having good dimensional accuracy by using a support material exhibiting excellent self-standing ability, an optically shaped article shaped using the optical shaping ink set, and a method for producing an optically shaped article in which the optical shaping ink set is used and the workability is excellent.

### BRIEF DESCRIPTION OF THE DRAWINGS

FIG. 1 is a diagram schematically illustrating a step (I) in a method for producing an optically shaped article according to the present embodiment.

FIG. 2 is a diagram schematically illustrating a step (II) in a method for producing an optically shaped article according to the present embodiment.

FIG. 3(a) is a top view of a cured product obtained using each composition for model material and each composition for support material shown in Table 3.

FIG. 3(b) is a cross-sectional view taken along the line A-A in FIG. 3(a).

### EMBODIMENTS OF THE INVENTION

Hereinafter, an embodiment of the present invention (hereinafter also referred to as the present embodiment) will be described in detail. The present invention is not limited to the following contents. Incidentally, in the following description, the term “(meth)acrylate” is a generic term for an acrylate and a methacrylate and means either or both of an acrylate and a methacrylate. The same applies to the terms of “(meth)acryloyl”, “(meth)acrylic” and “(meth)allyl”.

1. Composition for Model Material

<Monofunctional Ethylenically Unsaturated Monomer (A)>

The composition for model material contained in the optical shaping ink set according to the present embodiment comprises a monofunctional ethylenically unsaturated monomer (A). The monofunctional ethylenically unsaturated monomer (A) is not particularly limited as long as it is a compound having one ethylenically unsaturated group [a (meth)acryloyl group, a N-vinyl group or the like]. It is preferable that the monofunctional ethylenically unsaturated monomer (A) contains a hydrophobic monofunctional ethylenically unsaturated monomer (A1) (SP value is 10 or less) from the viewpoint of decreasing the SP value to be described later. In addition, the monofunctional ethylenically unsaturated monomer (A) may contain a water-soluble monofunctional ethylenic monomer (A2). Incidentally, in the present specification, to be soluble in water means that the solubility (25° C.) in water is 1 (g/100 g of water) or more.

Examples of the hydrophobic monofunctional ethylenically unsaturated monomer (A1) include linear or branched alkyl (meth)acrylates [compounds having 4 to 30 carbon atoms (hereinafter abbreviated as C), for example, isobutyl (meth)acrylate, lauryl (meth)acrylate, and stearyl (meth)acrylate]; alicyclic-containing (meth) acrylates [C6 to C20 compounds, for example, cyclohexyl (meth)acrylate, 4-t-butylcyclohexyl (meth)acrylate, 3,5,5-trimethylcyclohexyl (meth)acrylate, isobornyl (meth)acrylate, dicyclopentanyl (meth)acrylate, and 1-adamantyl (meth) acrylate]; and heterocyclic ring-containing (meth)acrylates [C4 to C20 compounds, for example, 3-ethyl-3-oxetanyl (meth)acrylate, tetrahydrofurfuryl (meth)acrylate, and 4-(meth)acryloyloxymethyl-2-methyl-2-ethyl-1,3-dioxolane]. These may be used singly, or two or more thereof may be used concurrently.

Among these, those having a high (50° C. or higher) glass transition point (hereinafter abbreviated as Tg) of a homopolymer of the hydrophobic monofunctional ethylenically unsaturated monomer (A1), namely, methyl (meth)acrylate, isobornyl (meth)acrylate, or dicyclopentanyl (meth)acrylate is more preferable, from the viewpoint of improving the shaping accuracy at the temperature (50° C. to 90° C.) at the time of photocuring of the composition for model material and of improving the heat resistance of the resurtant optically shaped article. In addition, isobornyl acrylate or dicyclopentanyl acrylate is more preferable from the viewpoint of improving photoreactivity.

Examples of the water-soluble monofunctional ethylenic monomer (A2) include C2 to C15 hydroxyl group-containing (meth)acrylates [hydroxyethyl (meth)acrylate, hydroxypropyl (meth)acrylate, and 4-hydroxybutyl (meth)acrylate]; alkylene oxide adduct-containing (meth)acrylates having a number average molecular weight [hereinafter abbreviated as Mn, the measurement of Mn is performed by gel permeation chromatography (GPC)] of 200 to 2,000 [polyethylene glycol (hereinafter abbreviated as PEG) mono(meth)acrylate, methoxypolyethylene glycol mono(meth)acrylate, and polypropylene glycol (hereinafter abbreviated as PPG) mono(meth)acrylate]; C3 to C15 (meth)acrylamide derivatives [(meth)acrylamide, N-methyl (meth)acrylamide, N,N-dimethyl (meth)acrylamide, N-ethyl (meth)acrylamide, and N,N-diethyl (meth)acrylamide], acryloyl morpholine, and 2-hydroxyethyl (meth)acrylamide. These may be used singly, or two or more thereof may be used concurrently.

The content of the monofunctional ethylenically unsaturated monomer (A) is 50 to 90 parts by weight with respect to 100 parts by weight of the total amount of the composition for model material from the viewpoint of improving the Tg and the resistance to brittleness of the model material and the optically shaped article produced using the model material. The content of the monofunctional ethylenically unsaturated monomer (A) is preferably 55 parts by weight or more and preferably 85 parts by weight or less. When the content of the monofunctional ethylenically unsaturated monomer (A) is less than 50 parts by weight, it is difficult to sufficiently improve the mechanical strength and the resistance to brittleness of a model material and the optically shaped article obtained from the composition for model material. Incidentally, the content is the sum of contents of the respective components (A) in a case in which two or more components (A) are contained.

In a case in which the monofunctional ethylenically unsaturated monomer (A) contains the water-soluble monofunctional ethylenic monomer (A2), the content of the water-soluble monofunctional ethylenic monomer (A2) is preferably 10 parts by weight or less, more preferably 5 parts by weight or less, and still more preferably 3 parts by weight or less with respect to 100 parts by weight of the total amount of the composition for model material, from the viewpoint of decreasing the water swelling rate of the model material to be described later. It is particularly preferable that the monofunctional ethylenically unsaturated monomer (A) does not contain the water-soluble monofunctional ethylenic monomer (A2).

<Polyfunctional Ethylenically Unsaturated Monomer (B) which does not Contain Urethane Group>

The composition for model material contained in the optical shaping ink set according to the present embodiment comprises a polyfunctional ethylenically unsaturated monomer (B) which does not contain a urethane group. The polyfunctional ethylenically unsaturated monomer (B) which does not have a urethane group is not particularly limited as long as it is a monomer which does not have a urethane group but has two or more ethylenically unsaturated groups. As the composition for model material contains the polyfunctional ethylenically unsaturated monomer (B) which does not contain a urethane group, it is possible to improve the mechanical strength and the elastic modulus of the model material and optically shaped article to be obtained.

It is preferable that the polyfunctional ethylenically unsaturated monomer (B) which does not contain a urethane group contains a hydrophobic polyfunctional ethylenically unsaturated monomer (B1) (SP value is 10 or less) which does not have a urethane group from the viewpoint of decreasing the SP value to be described later.

Examples of the hydrophobic polyfunctional ethylenically unsaturated monomer (B1) which does not have a urethane group include linear or branched alkylene glycol di(meth)acrylates [C4 to C25 compounds, for example, 1,6-hexanediol di(meth)acrylate, neopentyl glycol di(meth)acrylate, 1,9-nonanediol di(meth)acrylate, 3-methyl-1,5-pentanediol di(meth)acrylate, 2-n-butyl-2-ethyl-1,3-propanediol di(meth)acrylate, and trimethylolpropane triacrylate] and alicyclic-containing di(meth)acrylates [C6 to C30 compounds, for example, dimethylol tricyclodecane di(meth)acrylate and cyclohexane dimethylol diacrylate]. These may be used singly, or two or more thereof may be used concurrently.

Among these, those having a high (50° C. or higher) glass transition point (hereinafter abbreviated as Tg) of a homopolymer of the hydrophobic polyfunctional ethylenically unsaturated monomer (B1) which does not have a urethane group, namely, neopentyl glycol di(meth)acrylate, 3-methyl-1,5-pentanediol di(meth)acrylate, or dimethylol tricyclodecane di(meth)acrylate is preferable from the viewpoint of improving the shaping accuracy at the temperature (50° C. to 90° C.) at the time of photocuring of the composition for model material and of improving the heat resistance of the resultant optically shaped article. In addition, neopentyl glycol diacrylate, 3-methyl-1,5-pentanediol diacrylate, or dimethylol tricyclodecane diacrylate is more preferable from the viewpoint of improving photoreactivity.

The content of the polyfunctional ethylenically unsaturated monomer (B) which does not contain a urethane group is 3 to 25 parts by weight with respect to 100 parts by weight of the total amount of the composition for model material from the viewpoint of improving the mechanical strength and resistance to brittleness of the model material and optically shaped article. The content of the polyfunctional ethylenically unsaturated monomer (B) which does not contain a urethane group is preferably 4 parts by weight or more and preferably 20 parts by weight or less. The curing shrinkage becomes great, warpage of the model material at the time of shaping becomes great, and shaping accuracy deteriorates when the content of the polyfunctional ethylenically unsaturated monomer (B) exceeds 25 parts by weight. Incidentally, the content is the sum of contents of the respective components (B) in a case in which two or more components (B) are contained.

<Urethane Group-Containing Ethylenically Unsaturated Monomer (C)>

The composition for model material contained in the optical shaping ink set according to the present embodiment comprises a urethane group-containing ethylenically unsaturated monomer (C). The urethane group-containing ethylenically unsaturated monomer (C) is not particularly limited as long as it is a monomer which contains a urethane group and one or more ethylenically unsaturated groups. As the composition for model material contains the urethane group-containing ethylenically unsaturated monomer (C), it is possible to impart toughness to the model material and optically shaped article and thus to adjust the toughness and elongation of the model material and optically shaped article.

Examples of the urethane group-containing ethylenically unsaturated monomer (C) include monomers formed from a compound (x) having a hydroxyl group and a (meth)acryloyl group and a polyisocyanate (y). It is preferable that the urethane group-containing ethylenically unsaturated monomer (C) contains a hydrophobic urethane group-containing ethylenically unsaturated monomer (C1) (SP value is 10.9 or less) from the viewpoint of decreasing the SP value.

Examples of the compound (x) having a hydroxyl group and a (meth)acryloyl group include a compound having C5 or more and an Mn of 5,000 or less, for example, compounds presented in the following (x1) to (x5) and any mixture of two or more of these compounds.

(x1): 2-hydroxyethyl (meth)acrylate, 2-hydroxypropyl (meth)acrylate, 2-hydroxybutyl (meth)acrylate, those (molecular weight: 160 or more and Mn: 5,000 or less) obtained by adding alkylene oxide (hereinafter abbreviated as AO) to these, AO adduct of (meth)acrylic acid (number of carbon atoms of alkylene in AO: 2 to 4), and the like

(x2): ε-caprolactone adducts (molecular weight: 230 or more and Mn: 5,000 or less) of (x1), (meth)acrylic acid-2-hydroxyethyl-ε-caprolactone 2 mole adduct, and the like

(x3): reaction products of (meth) acrylic acid with diols (Mn 300 to 5,000), mono(meth)acrylate of diols [Mn 300 to 5,000, for example, polycarbonate diol, PEG, polyester diol, and the like]

(x4): reaction products (C8 to C30) of (meth)acrylic acid with epoxides, 3-phenoxy-2-hydroxypropyl (meth)acrylate, 3-biphenoxy-2-hydroxypropyl (meth)acrylate, and the like

(x5): glycerin mono- and di(meth)acrylates, trimethylol propane mono- and di(meth)acrylates, pentaerythritol mono-, di-, and tri(meth)acrylates, ditrimethylol propane mono-, di-, and tri(meth)acrylates, dipentaerythritol mono-, di-, tri-, tetra-, and penta(meth)acrylates, AO adducts thereof (number of moles added: 1 to 100), reaction products of (meth)acrylic acid with tri- or higher functional polyols (molecular weight: 92 or more and Mn: 5,000 or less), and the like

Among the compounds presented in (x1) to (x5), the compound (x) having a hydroxyl group and a (meth) acryloyl group is preferably (x1) or (x2) from the viewpoint of improving the toughness of the model material and optically shaped article.

Examples of the poly (di, tri or higher) isocyanate (y) include aromatic polyisocyanates [C6 to C20 compounds (excluding C in the NCO group, the same applies hereinafter), for example, 2,4- and/or 2,6-tolylene diisocyanate (TDI), and 4,4′- and/or 2,4′-diphenylmethane diisocyanate (MDI)], aliphatic polyisocyanates [C2 to C18 compounds, for example, hexamethylene diisocyanate (HDI)], alicyclic polyisocyanates [C4 to C45 compounds, for example, isophorone diisocyanate (IPDI), 2,4- and/or 2,6-methylcyclohexane diisocyanate (hydrogenated TDI), and dicyclohexylmethane-4,4′-diisocyanate (hydrogenated MDI)], aromatic aliphatic polyisocyanates [C8 to C15 compounds, for example, m- and/or p-xylylene diisocyanate (XDI), and α,α,α′,α′-tetramethyl xylylene diisocyanate (TMXDI)], and nurate compounds of these, and any mixtures thereof.

When producing the urethane group-containing ethylenically unsaturated monomer (C), a component (z) which has a hydroxyl group but does not have an unsaturated group except (x) above may be further contained as a reaction component from the viewpoint of improving the toughness and elongation of the model material and optically shaped article. Examples of the component (z) which has a hydroxyl group but does not have an unsaturated group include polyhydric alcohols having C1 or more and Mn of 3,000 or less (such as ethylene glycol, propylene glycol, glycerin, polyalkylene glycol and the like) and monohydric alcohols (methanol, ethanol and the like). Among these, a monohydric alcohol is preferable from the viewpoint of improving the impact resistance of the model material and optically shaped article.

The content of the urethane group-containing ethylenically unsaturated monomer (C) is 5 to 35 parts by weight with respect to 100 parts by weight of the total amount of the composition for model material from the viewpoint of improving the toughness and hardness of the model material and optically shaped article. The content of the urethane group-containing ethylenically unsaturated monomer (C) is preferably B parts by weight or more and preferably 30 parts by weight or less. Incidentally, the content is the sum of contents of the respective components (C) in a case in which two or more components (C) are contained.

The Mn of the urethane group-containing ethylenically unsaturated monomer (C) is preferably 500 or more and more preferably 700 or more from the viewpoint of improving the impact resistance of the model material and optically shaped article. In addition, the Mn of the urethane group-containing ethylenically unsaturated monomer (C) is preferably 5000 or less and more preferably 2000 or less from the viewpoint of improving the handleability of the composition for model material and the shaping accuracy of the model material and optically shaped article.

The number of functional groups in the ethylenically unsaturated group contained in the urethane group-containing ethylenically unsaturated monomer (C) is preferably 1 to 20 and more preferably 1 to 3 from the viewpoint of improving the hardness and impact resistance of the model material and optically shaped article.

<Photopolymerization Initiator (D)>

The resin composition for model material contained in the optical shaping ink set according to the present embodiment comprises a photopolymerization initiator (D). The photopolymerization initiator (D) is not particularly limited as long as it is a compound which promotes a radical reaction when being irradiated with light having a wavelength in the ultraviolet light, near ultraviolet light, or visible light region.

Examples of the photopolymerization initiator (D) include benzoin compounds having 14 to 18 carbon atoms (for example, benzoin, benzoin methyl ether, benzoin ethyl ether, benzoin propyl ether, and benzoin isobutyl ether), acetophenone compounds having 8 to 18 carbon atoms [for example, acetophenone, 2,2-diethoxy-2-phenylacetophenone, 2,2-diethoxy-2-phenylacetophenone, 1,1-dichloroacetophenone, 2-hydroxy-2-methyl-phenylpropan-1-one, diethoxyacetophenone, 1-hydroxycyclohexyl phenyl ketone, and 2-methyl-1-[4-(methylthio)phenyl]-2-morpholinopropan-1-one], anthraquinone compounds having 14 to 19 carbon atoms (for example, 2-ethyl anthraquinone, 2-t-butyl anthraquinone, 2-chloroanthraquinone, and 2-amyl anthraquinone), thioxanthone compounds having 13 to 17 carbon atoms [for example, 2,4-diethylthioxanthone, 2-isopropylthioxanthone, and 2-chlorothioxanthone], ketal compounds having 16 to 17 carbon atoms (for example, acetophenone dimethyl ketal and benzyl dimethyl ketal), benzophenone compounds having 13 to 21 carbon atoms (for example, benzophenone, 4-benzoyl-4′-methyldiphenyl sulfide, and 4,4′-bismethylaminobenzophenone), acylphosphine oxide compounds having 22 to 28 carbon atoms [for example, 2,4,6-trimethylbenzoyl-diphenyl-phosphine oxide, bis-(2,6-dimethoxybenzoyl)-2,4,4-trimethylpentylphosphine oxides, and bis(2,4,6-trimethylbenzoyl)-phenylphosphine oxide], and any mixture of these compounds. These may be used singly, or two or more thereof may be used concurrently. Among these, 2,4,6-trimethylbenzoyl-diphenyl-phosphine oxide is preferable from the viewpoint of improving the light resistance of a model material obtained by photocuring the composition for model material. In addition, examples of available acylphosphine oxide compounds include DAROCURE TPO manufactured by BASF.

The content of the photopolymerization initiator (D) is 0.1 to 10 parts by weight with respect to 100 parts by weight of the total amount of the composition for model material from the viewpoint of improving the photocuring speed and the mechanical properties of the model material and optically shaped article. The content of the photopolymerization initiator (D) is preferably 0.3 parts by weight or more and preferably 8 parts by weight or less.

<Other Additives>

The composition for model material contained in the optical shaping ink set according to the present embodiment can comprise the other additives if necessary in the range in which the effect of the present invention is not inhibited. Examples of the other additives include a polymerization inhibitor, a surfactant, a coloring agent, an antioxidant, a chain transfer agent, and a filler. These may be used singly, or two or more thereof may be used concurrently.

It is preferable that the composition for model material comprises a polymerization inhibitor. As the composition for model material contains a polymerization inhibitor, it is possible to suppress excessive polymerization at the temperature (about 50° C. to 90° C.) at which the optically shaped article is shaped. As a result, the monomer can be stabilized, and the composition for model material is easily cured.

Examples of the polymerization inhibitor include phenol compounds [hydroquinone, hydroquinone monomethyl ether and the like], sulfur compounds [dilaurylthiodipropionate and the like], phosphorus compounds [triphenyl phosphite and the like], and amine compounds [phenothiazine and the like]. These may be used singly, or two or more thereof may be used concurrently.

The content of the polymerization inhibitor is preferably 5 parts by weight or less, more preferably 3 parts by weight or less, and preferably 0.1 parts by weight or more with respect to 100 parts by weight of the total amount of the composition for model material from the viewpoint of improving the monomer stability and the polymerization speed. Incidentally, the content is the sum of contents of the respective polymerization inhibitors in a case in which two or more polymerization inhibitors are contained.

Examples of the surfactant include PEG type nonionic surfactants having a molecular weight of 264 or more and an Mn of 5,000 or less [ethylene oxide (hereinafter abbreviated as EO) of nonylphenol (EO 1 to 40 mole adduct), stearic acid EO 1 to 40 mole adduct and the like], polyhydric alcohol type nonionic surfactants (sorbitan palmitic acid monoesters, sorbitan stearic acid monoesters, sorbitan stearic acid triesters and the like), fluorine-containing surfactants (perfluoroalkyl EO 1 to 50 mole adducts, perfluoroalkyl carboxylates, perfluoroalkyl betaines and the like), and modified silicone oil [polyether-modified silicone oil, (meth)acrylate-modified silicone oil and the like]. These may be used singly, or two or more thereof may be used concurrently.

The content of the surfactant is preferably 3 parts by weight or less, more preferably 2 parts by weight or less, and more preferably 0.1 parts by weight or more with respect to 100 parts by weight of the total amount of the composition for model material from the viewpoint of improving the addition effect and the physical properties of the model material and optically shaped article. Incidentally, the content is the sum of contents of the respective surfactants in a case in which two or more surfactants are contained.

Examples of the coloring agent include a pigment and a dye. These may be used singly, or two or more thereof may be used concurrently.

The pigment includes an organic pigment and/or an inorganic pigment. Examples of the organic pigment include the pigments exemplified below.

(Azo Pigment)

Insoluble monoazo pigments (Toluidine Red, Permanent Carmine FB, Fast Yellow G etc.);

(Polycyclic Pigment)

Phthalocyanine Blue etc.;

(Color Lake)

Basic dyes (Victoria Pure Blue BO Lake etc.) and the like;

(Other Pigments)

Azine pigments (Aniline Black etc.), daylight fluorescent pigments, nitroso pigments, nitro pigments, natural pigments and the like.

Examples of the inorganic pigment include metal oxides (iron oxide, chromium oxide, titanium oxide etc.) and carbon black.

The content of the coloring agent is preferably 2 parts by weight or less, more preferably 1 part by weight or less, and preferably 0.1 parts by weight or more with respect to 100 parts by weight of the total amount of the composition for model material from the viewpoint of improving the coloration effect and the physical properties of the model material and optically shaped article. Incidentally, the content is the sum of contents of the respective coloring agents in a case in which two or more coloring agents are contained.

Examples of the antioxidant include phenol compounds [monocyclic phenols (2,6-di-t-butyl-p-cresol etc.).

The content of the antioxidant is preferably 3 parts by weight or less, more preferably 2 parts by weight or less, and preferably 0.1 parts by weight or more with respect to 100 parts by weight of the total amount of the composition for model material from the viewpoint of improving the antioxidation effect and the physical properties of the model material and optically shaped article. Incidentally, the content is the sum of contents of the respective antioxidants in a case in which two or more antioxidants are contained.

Examples of the chain transfer agent include hydrocarbons [C6 to C24 compounds, for example, aromatic hydrocarbons (toluene, xylene etc.) and unsaturated aliphatic hydrocarbons (1-butene, 1-nonene etc.)]; and halogenated hydrocarbons (C1 to C24 compounds, for example, dichloromethane and carbon tetrachloride). These may be used singly, or two or more thereof may be used concurrently.

The content of the chain transfer agent is preferably 10 parts by weight or less, more preferably 5 parts by weight or less, and more preferably 0.05 parts by weight or more with respect to 100 parts by weight of the total amount of the composition for model material from the viewpoint of improving the polymerizability of the monomer and the compatibility between the monomer and the chain transfer agent. Incidentally, the content is the sum of contents of the respective chain transfer agents in a case in which two or more chain transfer agents are contained.

Examples of the filler include metal powder (aluminum powder, copper powder etc.), metal oxides (alumina, silica, talc, mica, clay etc.), metal hydroxides (aluminum hydroxide etc.), metal salts (calcium carbonate, calcium silicate etc.), fibers [inorganic fibers (carbon fiber, glass fiber, asbestos etc.), organic fibers (cotton, nylon, acrylic, rayon fibers etc.) and the like], micro balloons (glass, shirasu, phenol resin etc.), carbon (carbon black, graphite, coal powder etc.), metal sulfides (molybdenum disulfide etc.), and organic powders (wood powder etc.). These may be used singly, or two or more thereof may be used concurrently.

The content of the filler is preferably 30 parts by weight or less, more preferably 20 parts by weight or less, and preferably 3 parts by weight or more with respect to 100 parts by weight of the total amount of the composition for model material from the viewpoint of improving the filling effect, the inkjet dischargeable viscosity, and the physical properties of the model material and optically shaped article. Incidentally, the content is the sum of contents of the respective fillers in a case in which two or more fillers are contained.

The content of the other additives is preferably 30 parts by weight or less, more preferably 20 parts by weight or less, and preferably 0.05 parts by weight or more with respect to 100 parts by weight of the total amount of the composition for model material from the viewpoint of improving the addition effect and the physical properties of the model material and optically shaped article. Incidentally, the content is the sum of contents of the respective other additives in a case in which two or more other additives are contained.

In the composition for model material contained in the optical shaping ink set according to the present embodiment, the content of water-soluble components is preferably 10 parts by weight or less and more preferably 5 parts by weight or less with respect to 100 parts by weight of the total amount of the composition for model material from the viewpoint of preventing deformation of the model material and optically shaped article due to water swelling and moisture absorption.

Here, the water-soluble components refer to components having a solubility in water of 1 (g/100 g of water) or more at 25° C. In other words, the water-soluble components refer to the components which exhibit the solubility described above among the components (A) to (D) and other additives contained in the composition for model material.

<Weighted Average Value of SP Value>

It is preferable that the composition for model material contained in the optical shaping ink set according to the present embodiment has a weighted average value of SP values of 9.0 to 10.3. When the weighted average value of SP values is less than 9.0, the model material obtained by photocuring the composition for model material is brittle and thus the toughness of the model material may be diminished. On the other hand, when the weighted average value of SP values exceeds 10.3, the model material may be swollen by water and deformed when being immersed in water or washed with water jets in order to remove the support material obtained by photocuring the composition for support material to be described later. As a result, the model material may not return to its original shape even when being dried. In addition, deformation of the model material due to moisture absorption may easily occur as the model material is left in the air. The weighted average value of SP values is more preferably 9.2 or more and more preferably 10.0 or less. Incidentally, the weighted average value of SP values can be adjusted by changing the kinds and contents of the photocurable components (A) to (C) constituting the composition for model material.

Here, the SP value means a solubility parameter and is a value to be a measure of the mutual solubility of substances. More specifically, the SP value is a value determined according to the following Equation (i). Generally, it is known that the mutual solubility of substances is greater as the difference in SP value is smaller.

SP=[(ΔH−RT)/V]^{1/2} (i)

The meanings of the respective symbols in Equation (i) are as follows.

V: molar volume (cc/mol)

ΔH: latent heat of vaporization (cal/mol)

R: gas constant 1.987 cal/mol·K

In addition, the SP value of copolymer or mixture can be calculated by the method proposed by Fedors et al. described in the following document. In the above method, a weighted average value of SP values can be calculated by proportionately distributing the SP value of the constituent monomers in the case of copolymer and the SP values of the constituent components in the case of mixture by the respective constitutional proportions (W by weight) assuming that the sum rule is established in the SP value of copolymer or mixture.

“POLYMER ENGINEERING AND SCIENCE, FEBRUARY, 1974, Vol. 14, No. 2, Robert F. Fedors. (pages. 147 to 154)”

The method for producing the composition for model material contained in the optical shaping ink set according to the present embodiment is not particularly limited. For example, the composition for model material can be produced by uniformly mixing the components (A) to (D) and, if necessary, the other additives using a mixing and stirring apparatus and the like.

It is preferable that the composition for model material produced in this manner has a viscosity of 70 mPa·s or less at 25° C. from the viewpoint of improving the dischargeability from the inkjet head. Incidentally, the measurement of the viscosity of the composition for model material is performed using R100 type viscometer in accordance with JIS Z 8803.

A model material is obtained by photocuring the composition for model material contained in the optical shaping ink set according to the present embodiment. The description in detail will be given in the method for producing an optically shaped article to be described later. The model material preferably has a Tg of 50° C. to 120° C. The model material is usually shaped at 50° C. to 90° C. For this reason, when the Tg of the model material is 50° C. to 120° C., the heat resistance of the model material and optically shaped article can be improved and the warpage of the model material and optically shaped article can be diminished. The Tg of the model material is more preferably 55° C. or higher and still more preferably 60° C. or higher. In addition, the Tg of the model material is more preferably 110° C. or lower and still more preferably 100° C. The Tg of the model material can be adjusted by changing the kinds and contents of the components (A) to (D) and the other additives contained in the composition for model material. Incidentally, the Tg of the model material can be measured by the DMA (Dynamic Mechanical Analysis) method.

The water swelling rate of the model material is preferably 1% by weight or less, more preferably 0.7% by weight or less, and still more preferably 0.5% by weight or less from the viewpoint of improving the dimensional accuracy. The water swelling rate of the model material can be adjusted by changing the kinds and contents of the components (A) to (D) and the other additives contained in the composition for model material. Incidentally, the water swelling rate of the model material can be determined by the following Equation (ii) in accordance with the water absorption rate measurement method of ASTM D570. However, ion exchanged water is used as water and the water temperature is set to 25° C.

Water swelling rate (%)=100×(weight after water immersion−weight before water immersion)/(weight before water immersion) (ii)

The deformation volume of the model material by water swelling is preferably 2 mm or less, more preferably 1 mm or less, and still more preferably 0.5 mm or less from the viewpoint of improving the dimensional accuracy. The deformation volume of the model material by water swelling can be adjusted by changing the kinds and contents of the components (A) to (D) and the other additives contained in the composition for model material. Incidentally, the deformation volume of the model material by water swelling can be determined by measuring the maximum distance (mm) between the end portion of the test piece at which warpage is acknowledged and the table surface when a test piece immersed in water is taken out of the water and immediately placed on a table horizontally in accordance with the water absorption rate measurement method of ASTM D570.

2. Composition for Support Material

<Water-Soluble Monofunctional Ethylenically Unsaturated Monomer (a)>

The composition for support material contained in the optical shaping ink set according to the present embodiment comprises a water-soluble monofunctional ethylenically unsaturated monomer (a). The water-soluble monofunctional ethylenically unsaturated monomer (a) is a component which is polymerized by being irradiated with light to cure the composition for support material. Moreover, the water-soluble monofunctional ethylenically unsaturated monomer (a) is a component which quickly dissolves the support material obtained by photocuring the composition for support materials in water.

The water-soluble monofunctional ethylenically unsaturated monomer (a) is a water-soluble polymerizable monomer having one ethylenic double bond in the molecule exhibiting the property of being cured by energy rays. Examples of the water-soluble monofunctional ethylenically unsaturated monomer (a) include hydroxyl group-containing (meth)acrylates having 5 to 15 carbon atoms [for example, hydroxyethyl (meth)acrylate, hydroxypropyl (meth)acrylate, and 4-hydroxybutyl (meth)acrylate], alkylene oxide adduct-containing (meth)acrylates having an Mn of 200 to 1,000 [polyethylene glycol mono(meth)acrylate, monoalkoxy (1 to 4 carbon atoms) polyethylene glycol mono(meth)acrylate, monoalkoxy (1 to 4 carbon atoms) polypropylene glycol mono(meth)acrylate and the like], (meth)acrylamide derivatives having 3 to 15 carbon atoms [(meth)acrylamide, N-methyl (meth)acrylamide, N-ethyl (meth)acrylamide and the like], and (meth)acryloyl morpholine. These may be used singly, or two or more thereof may be used concurrently.

Among these, N,N′-dimethyl (meth)acrylamide, N-hydroxyethyl (meth)acrylamide, (meth)acryloyl morpholine and the like are preferable from the viewpoint of improving the curability of the composition for support material. Furthermore, it is more preferable that the water-soluble monofunctional ethylenically unsaturated monomer (a) is (meth)acryloyl morpholine from the viewpoint of low skin irritation to the human body.

The content of the water-soluble monofunctional ethylenically unsaturated monomer (a) is 20 to 50 parts by weight with respect to 100 parts by weight of the total amount of the composition for support material. When the content of the water-soluble monofunctional ethylenically unsaturated monomer (a) is less than 20 parts by weight, the self-standing ability of the support material is not sufficient. For this reason, the model material cannot be sufficiently supported when the support material is disposed in the lower layer of the model material. As a result, the dimensional accuracy of the model material deteriorates. On the other hand, when the content of the water-soluble monofunctional ethylenically unsaturated monomer (a) exceeds 50 parts by weight, the support material is inferior in the solubility in water. When the immersion time in water until the support material is completely removed is long, the model material slightly expands. As a result, the dimensional accuracy may deteriorate at the microstructure portion of the model material. The content of the water-soluble monofunctional ethylenically unsaturated monomer (a) is preferably 25 parts by weight or more and preferably 45 parts by weight or less. Incidentally, the content is the sum of contents of the respective components (a) in a case in which two or more components (a) are contained.

<Polyalkylene Glycol (b) Containing Oxyethylene Group and/or Oxypropylene Group>

The composition for support material contained in the optical shaping ink set according to the present embodiment comprises a polyalkylene glycol (b) containing an oxyethylene group and/or an oxypropylene group. The polyalkylene glycol (b) can enhance the solubility of the support material in water.

The polyalkylene glycol (b) is obtained by adding at least ethylene oxide and/or propylene oxide to an active hydrogen compound. Examples of the polyalkylene glycol (b) include polyethylene glycol and polypropylene glycol. These may be used singly, or two or more thereof may be used concurrently. Examples of the active hydrogen compound include monohydric to tetrahydric alcohols and amine compounds. Among these, a dihydric alcohol or water is preferable.

The number average molecular weight Mn of the polyalkylene glycol (b) is preferably 100 to 5,000. When the Mn of the polyalkylene glycol (b) is in the above range, the polyalkylene glycol (b) is compatible with the water-soluble monofunctional ethylenically unsaturated monomer (a) before photocuring and is incompatible with the water-soluble monofunctional ethylenically unsaturated monomer (a) after photocuring. As a result, the self-standing ability of the support material can be improved and the solubility of the support material in water can be enhanced. The Mn of the polyalkylene glycol (b) is more preferably 200 to 3,000 and still more preferably 400 to 2,000.

The content of the polyalkylene glycol (b) is set to 20 to 49 parts by weight with respect to 100 parts by weight of the total amount of the composition for support material. When the content of the polyalkylene glycol (b) is less than 20 parts by weight, the support material is inferior in the solubility in water. When the immersion time in water until the support material is completely removed is long, the model material slightly expands. As a result, the dimensional accuracy may deteriorate at the microstructure portion of the model material. On the other hand, when the content of the polyalkylene glycol (b) exceeds 49 parts by weight, exudation of the polyalkylene glycol (b) may occur when the composition for support material is photocured. When the exudation of the polyalkylene glycol (b) occurs, the adhesive property at the interface between the support material and the model material deteriorates. As a result, the model material may be easily peeled off from the support material when being cured and shrunk and the dimensional accuracy thereof may deteriorate. In addition, when the content of the polyalkylene glycol (b) exceeds 49 parts by weight, the viscosity of the composition for support material increases. For this reason, the jetting property may deteriorate and flight bending may be caused when the composition for support material is discharged from the inkjet head. As a result, the dimensional accuracy of the support material deteriorates. Consequently, the dimensional accuracy of the model material formed on the upper layer of the support material also deteriorates. The content of the polyalkylene glycol (b) is preferably 25 parts by weight or more and preferably 45 parts by weight or less. Incidentally, the content is the sum of contents of the respective components (b) in a case in which two or more components (b) are contained.

<Water-Soluble Organic Solvent (c)>

The composition for support material contained in the optical shaping ink set according to the present embodiment comprises a water-soluble organic solvent (c). The water-soluble organic solvent (c) is a component which improves the solubility of the support material in water. Moreover, the water-soluble organic solvent (c) is a component which adjusts the viscosity of the composition for support materials to a lower value.

Examples of the water-soluble organic solvent (c) include ethylene glycol monoacetate, propylene glycol monoacetate, tripropylene glycol monoacetate, tetraethylene glycol monoacetate, ethylene glycol monomethyl ether, propylene glycol monomethyl ether, ethylene glycol monoethyl ether, propylene glycol monoethyl ether, triethylene glycol monomethyl ether, ethylene glycol monopropyl ether, propylene glycol monopropyl ether, ethylene glycol monobutyl ether, propylene glycol monobutyl ether, ethylene glycol diacetate, propylene glycol diacetate, ethylene glycol dimethyl ether, propylene glycol dimethyl ether, ethylene glycol diethyl ether, propylene glycol diethyl ether, ethylene glycol dipropyl ether, propylene glycol dipropyl ether, ethylene glycol dibutyl ether, propylene glycol dibutyl ether, ethylene glycol monomethyl ether acetate, propylene glycol monomethyl ether acetate, ethylene glycol monoethyl ether acetate, propylene glycol monoethyl ether acetate, ethylene glycol monopropyl ether acetate, propylene glycol monopropyl ether acetate, ethylene glycol monobutyl ether acetate, and propylene glycol monobutyl ether acetate. These may be used singly, or two or more thereof may be used concurrently. Among these, triethylene glycol monomethyl ether is more preferable from the viewpoint of improving the solubility of the support material in water and adjusting the viscosity of the composition for support materials to a lower value.

The content of the water-soluble organic solvent (c) is 35 parts by weight or less with respect to 100 parts by weight of the total amount of the composition for support material. When the content of the water-soluble organic solvent (c) exceeds 35 parts by weight, exudation of the water-soluble organic solvent (c) occurs when the composition for support material is photocured. For this reason, the dimensional accuracy of the model material formed on the upper layer of the support material deteriorates. The content of the water-soluble organic solvent (c) is preferably 5 parts by weight or more and more preferably 10 parts by weight or more from the viewpoint of improving the solubility of the support material in water and adjusting the viscosity of the composition for support materials to a lower value. Moreover, the content of the water-soluble organic solvent (c) is preferably 30 parts by weight or less. Incidentally, the content is the sum of contents of the respective components (c) in a case in which two or more components (c) are contained.

<Photopolymerization Initiator (d)>

The composition for support material contained in the optical shaping ink set according to the present embodiment comprises a photopolymerization initiator (d). As the photopolymerization initiator (d), the components which are the same as the photopolymerization initiator (D) contained in the composition for model material can be used.

The content of the photopolymerization initiator (d) is preferably 1 to 25 parts by weight and more preferably 2 to 20 parts by weight with respect to 100 parts by weight of the total amount of the composition for support material. When the content of the photopolymerization initiator (d) is in the above range, the self-standing ability of the composition for support material is improved. For this reason, the dimensional accuracy of the model material formed on the upper layer of the support material formed from this composition for support material is improved. The content of the photopolymerization initiator (d) is more preferably 3 parts by weight or more, still more preferably 5 parts by weight or more, particularly preferably 7 parts by weight or more, and more preferably 18 parts by weight or less. Incidentally, the content is the sum of contents of the respective components (d) in a case in which two or more components (d) are contained.

<Surface Conditioner (e)>

It is preferable that the composition for support material contained in the optical shaping ink set according to the present embodiment comprises a surface conditioner (e) in order to adjust the surface tension of the composition to a proper range. By adjusting the surface tension of the composition to a proper range, it is possible to suppress mixing of the composition for model material with the composition for support material at the interface. As a result, it is possible to obtain an optically shaped article having good dimensional accuracy by use of these compositions. In order to attain this effect, it is preferable that the content of the surface conditioner (e) is 0.005 to 3.0 parts by weight with respect to 100 parts by weight of the total amount of the composition for support material.

Examples of the surface conditioner (e) include silicone-based compounds. Examples of the silicone-based compounds include silicone-based compounds having a polydimethylsiloxane structure. Specific examples include polyether-modified polydimethylsiloxane, polyester-modified polydimethylsiloxane, and polyaralkyl-modified polydimethylsiloxane. As these, BYK-300, BYK-302, BYK-306, BYK-UV 3500, BYK-UV 3510, and BYK-UV 3570 of trade names (all manufactured by BYK) and TEGO-Rad 2100, TEGO-Rad 2200N, TEGO-Rad 2250, TEGO-Rad 2300, TEGO-Rad 2500, TEGO-Rad 2600, and TEGO-Rad 2700 of trade names (all manufactured by Degussa) may be used. These may be used singly, or two or more thereof may be used concurrently. Incidentally, the content is the sum of contents of the respective components (e) in a case in which two or more components (e) are contained.

<Storage Stabilizer (f)>

The composition for support material contained in the optical shaping ink set according to the present embodiment further comprises a storage stabilizer (f). The storage stabilizer (f) can enhance the storage stability of the composition. In addition, the storage stabilizer (f) can prevent head clogging caused by the polymerization of polymerizable compounds by thermal energy. In order to attain this effect, it is preferable that the content of the storage stabilizer (f) is 0.05 to 3.0 parts by weight with respect to 100 parts by weight of the total amount of the composition for support material.

Examples of the storage stabilizer (f) include hindered amine-based compounds (HALS), phenol-based antioxidants, and phosphorus-based antioxidants. Specific examples include hydroquinone, methoquinone, benzoquinone, p-methoxyphenol, hydroquinone monomethyl ether, hydroquinone monobutyl ether, TEMPO, 4-hydroxy-TEMPO, TEMPOL, cupferron A1, IRGASTAB UV-10, IRGASTAB UV-22, FIRSTCURE ST-1 (manufactured by ALBEMARLE CORPORATION), t-butyl catechol, pyrogallol, and TINUVIN 111 FDL, TINUVIN 144, TINUVIN 292, TINUVIN XP40, TINUVIN XP60, and TINUVIN 400 manufactured by BASF. These may be used singly, or two or more thereof may be used concurrently. Incidentally, the content is the sum of contents of the respective components (f) in a case in which two or more components (f) are contained.

The composition for support material contained in the optical shaping ink set according to the present embodiment can comprise the other additives if necessary in the range in which the effect of the present invention is not inhibited. Examples of the other additives include an antioxidant, a coloring agent, an ultraviolet light absorber, a light stabilizer, a polymerization inhibitor, a chain transfer agent, and a filler.

The method for producing the composition for support material contained in the optical shaping ink set according to the present embodiment is not particularly limited. For example, the composition for support material can be produced by uniformly mixing the components (a) to (d) and, if necessary, the components (e) and (f) and the other additives using a mixing and stirring apparatus and the like.

It is preferable that the composition for support material produced in this manner has a viscosity of 70 mPa·s or less at 25° C. from the viewpoint of improving the dischargeability from the inkjet head. Incidentally, the measurement of the viscosity of the composition for support material is performed using R100 type viscometer in accordance with JIS Z 8803.

3. Optically Shaped Article and Method for Producing the Same

The optically shaped article according to the present embodiment is shaped using the optical shaping ink set according to the present embodiment. Specifically, the optically shaped article is produced by an inkjet optical shaping method through a step (I) of photocuring the composition for model material described above to obtain a model material and, at the same time, photocuring the composition for support material described above to obtain a support material and a step (II) of removing the support material. The step (I) and the step (II) are not particularly limited but are performed, for example, by the following methods.

<Step (I)>

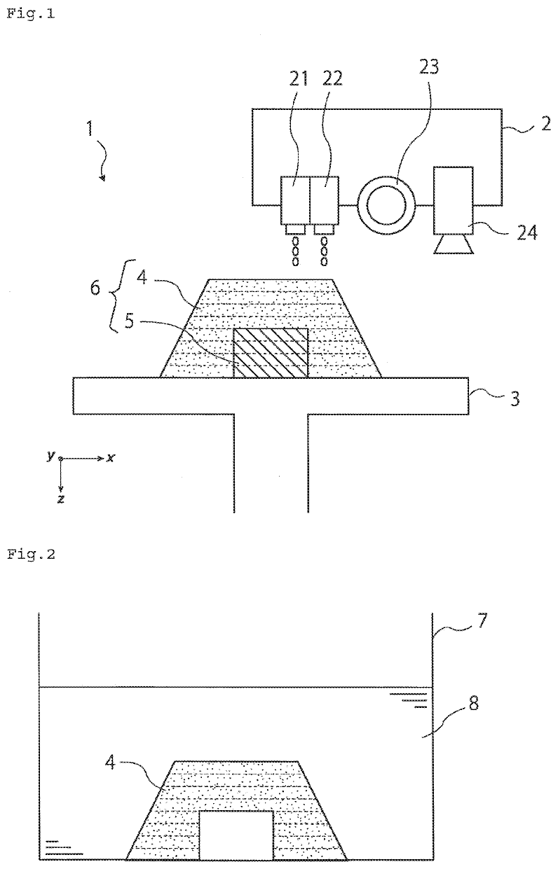

FIG. 1 is a diagram schematically illustrating the step (I) in the method for producing an optically shaped article according to the present embodiment. As illustrated in FIG. 1, a three-dimensional shaping apparatus 1 includes an inkjet head module 2 and a shaping table 3. The inkjet head module 2 includes an inkjet head for model material 21 filled with the composition for model material, an inkjet head for support material 22 filled with the composition for support material, a roller 23, and a light source 24.

First, the inkjet head module 2 is made to perform scanning in an X direction and a Y direction relatively to the shaping table 3 in FIG. 1, and at the same time, the composition for model material is discharged from the inkjet head for model material 21, and the composition for support material is discharged from the inkjet head for support material 22, and thereby, a composition layer composed of the composition for model material and the composition for support material is formed. In order to smooth an upper surface of the composition layer, the extra composition for model material and the extra composition for support material are removed using the roller 23. These compositions are irradiated with light using the light source 24, and thereby, a cured layer composed of a model material 4 and a support material 5 is formed on the shaping table 3.

Then, the shaping table 3 is lowered in a Z direction in FIG. 1 by the thickness of the cured layer. Thereafter, by the same method as that described above, a cured layer composed of a model material 4 and a support material 5 is further formed on the cured layer. By repeatedly performing these steps, a cured product 6 composed of a model material 4 and a support material 5 is prepared.

Examples of light for curing the composition include far infrared rays, infrared rays, visible rays, near ultraviolet rays, ultraviolet rays. From a viewpoint of easiness and efficiency of the curing work, among them, near ultraviolet rays or ultraviolet rays are preferable.

Examples of the light source 24 include a mercury lamp, a metal halide lamp, an ultraviolet LED, and an ultraviolet laser. Among these, from the viewpoint of miniaturization of facility and power saving, an ultraviolet LED is preferable. Incidentally, it is preferable that the integrated light quantity of the ultraviolet light is about 500 mJ/cm² in the case of using an ultraviolet LED as the light source 24.

<Step (II)>

FIG. 2 is a diagram schematically illustrating the step (II) in the method for producing an optically shaped article according to the present embodiment. As illustrated in FIG. 2, the cured product 6 composed of the model material 4 and the support material 5 prepared in the step (I) is immersed in a solvent 8 contained in a vessel 7. Thereby, the support material 5 can be dissolved in the solvent 8 and removed.

Examples of the solvent 8 for dissolving the support material include ion exchanged water, distilled water, tap water, and well water. Among these, ion exchanged water is preferable from the viewpoint of containing impurities in a relatively small amount and of being available at low cost.

The method for producing an optically shaped article according to the present embodiment is excellent in workability since the support material exhibits high self-standing ability and it is thus not required to use a wall and the like for supporting the support material.

The optically shaped article according to the present embodiment can be obtained through the above steps. As described above, by use of the optical shaping ink set according to the present embodiment, it is possible to obtain a model material to be extremely slightly deformed by swelling by photocuring the composition for model material contained in the optical shaping ink set. In addition, by use of the optical shaping ink set according to the present embodiment, it is possible to obtain a support material exhibiting excellent self-standing ability by photocuring the composition for support material contained in the optical shaping ink set. The optically shaped article produced using such a model material and such a support material has good dimensional accuracy.

Hereinafter, Examples which disclose the present embodiment more specifically will be described. Incidentally, the present invention is not limited only to these Examples.

### EXAMPLES

<Composition for Model Material>

(Production of Composition for Model Material)

Compositions for model material of Examples M1 to M4 and Comparative Examples m1 and m2 were produced by uniformly mixing the components (A) to (D) at the proportions shown in Table 1 using a mixing and stirring apparatus.

TABLE 1

| | | | | | | | | | Comparative | |
|---|---|---|---|---|---|---|---|---|---|---|
| | | | | SP | Example | | | | Example | |
| Composition for model material | | | | value | M1 | M2 | M3 | M4 | m1 | m2 |
| Proportion | (A) | Monofunctional | IBXA | 9.6 | 60 | 80 | 50 | — | 20* | — |
| (parts by | | ethylenically | ACMO | 12.7 | — | — | 10 | — | — | 40 |
| weight) | | unsaturated | 1-AdA | 9.3 | — | — | — | 18 | — | — |
| | | monomer | STA | 8.7 | — | — | — | 62 | — | 40 |
| | (B) | Ployfunctional ethylenically | DCP-A | 9.9 | 20 | 10 | 10 | 15 | 25 | — |
| | | unsaturated monomer which | | | | | | | | |
| | | does not contain urethane | SR-351 | 9.7 | — | — | — | — | — | 50* |
| | | group | | | | | | | | |
| | (C) | Urethane group- | C1 | 10.7 | 20 | — | 30 | — | — | — |
| | | containing ethylenically | C2 | 9.7 | — | 10 | — | 5 | — | 10 |
| | | unsaturated monomer | Photomer6010 | 10.7 | — | — | — | — | 10 | — |
| | (D) | Photopolymerization | LUCIRIN TPO | 11.1 | 5 | — | 3 | 1 | 3 | 3 |
| | | initiator | IRGACURE 184 | 12.2 | — | 5 | 3 | — | — | — |

| | | | | | | |
|---|---|---|---|---|---|---|
| Weighted average value of SP value | 9.9 | 9.7 | 10.3 | 9.0 | 8.8 | 10.5 |

*means that the value is deviated from the range regulated in the present invention.

The contents of water-soluble components (ACMO) in the compositions for model material of Examples M1, M2, and M4 and Comparative Example m1 were respectively 0% by mass, the content of water-soluble components in the composition for model material of Example M3 was 9.4% by mass, and the content of water-soluble components in the composition for model material of Comparative Example m2 was 28.0% by mass.

The glass transition temperatures (Tg) of the compositions for model material of Examples M1 to M4 and Comparative Examples m1 and m2 were M1=90° C., M2=88° C., M3=73° C., M4=80° C., m1=67° C., and m2=65° C., respectively.

### Production Example 1

In a reaction vessel, 100 parts of a caprolactone adduct of 2-hydroxyethyl acrylate [trade name “PLACCEL FA-4D” manufactured by DAICEL CORPORATION, number of moles added: 4], 64 parts of a nurate of IPDI [trade name “VESTANAT T1890” manufactured by Evonik Industries AG], and 0.03 parts of a urethanized catalyst [bismuth tri (2-ethylhexanoate) (50% solution of 2-ethylhexanoic acid), hereinafter the same applies.] were charged and reacted at 80° C. for 12 hours to obtain a urethane acrylate (C1). The Mn of (C1) was 1,730.

### Production Example 2

In a reaction vessel, 100 parts of polytetramethylene glycol (trade name “PTMG-1000” manufactured by Mitsubishi Chemical Corporation, Mn: 1,000), 33.3 parts of IPDI, and 0.05 parts of a urethanized catalyst were charged and reacted at 80° C. for 4 hours, and then 11.6 parts of 2-hydroxyethyl acrylate was added (NCO/OH equivalent ratio=1/1) to the reaction mixture, and the mixture was reacted at 80° C. for 8 hours to obtain a urethanized acrylate (C2). The Mn of (C2) was 1,606.

IBXA: Isobornyl acrylate [LIGHT ACRYLATE IBXA (ethylenic double bond/1 molecule: 1) manufactured by KYOEISHA CHEMICAL CO., LTD.]

ACMO: Acryloyl morpholine [ACMO (ethylenic double bond/1 molecule: 1) manufactured by KOHJIN CO., LTD.]

1-AdA: 1-Adamantyl acrylate [1-AdA (ethylenic double bond/1 molecule: 1), manufactured by OSAKA ORGANIC CHEMICAL INDUSTRY LTD.]

STA: Stearyl acrylate [STA (ethylenic double bond/1 molecule: 1), manufactured by OSAKA ORGANIC CHEMICAL INDUSTRY LTD.]

DCP-A: Dicyclopentane dimethylol diacrylate [LIGHT ACRYLATE DCP-A (ethylenic double bond/1 molecule: 2) manufactured by KYOEISHA CHEMICAL CO., LTD.]

SR-351: Trimethylolpropane triacrylate [SR-351 (ethylenic double bond/1 molecule: 3) manufactured by Sartomer]

Photomer 6010: Urethane acrylate oligomer [Photomer 6010 (ethylenic double bond/1 molecule: 2) manufactured by COGNIS]

LUCIRIN TPO: 2,4,6-Trimethylbenzoyl-diphenyl-phosphine oxide (LUCIRIN TPO manufactured by BASF)

IRGACURE 184: 1-Hydroxycyclohexyl phenyl ketone [IRGACURE 184 manufactured by Ciba Specialty Chemicals]

<Composition for Support Material>

(Production of Composition for Support Material)

Compositions for support material of Examples S1 to S15 and Comparative Example s1 were produced by uniformly mixing the components (a) to (f) at the proportions shown in Table 2 using a mixing and stirring apparatus. Thereafter, the following evaluation was performed using these compositions for support material.

TABLE 2

| | | | | Example | | | | | | | | | |
|---|---|---|---|---|---|---|---|---|---|---|---|---|---|
| Composition for support material | | | | S1 | S2 | S3 | S4 | S5 | S6 | S7 | S8 | S9 | S10 |
| Proportion | (a) | Water-soluble | HEAA | 25 | 25 | 25 | 25 | 25 | — | — | — | — | — |
| (parts by | | ethylenically | ACMO | — | — | — | — | — | 25 | — | 20 | 50 | 41.6 |
| weight) | | unsaturated | DMAA | — | — | — | — | — | — | 25 | — | — | — |
| | | monomer | | | | | | | | | | | |
| | (b) | Polyalkylene glycol | PPG-400 | 45 | — | — | — | — | — | — | — | — | — |
| | | containing oxyethylene | PPG-1000 | — | 45 | — | — | 45 | 45 | 45 | 45 | 30 | 45 |
| | | group and/or | PEG-400 | — | — | 45 | — | — | — | — | — | — | — |
| | | oxypropylene group | PEG-1000 | — | — | — | 45 | — | — | — | — | — | — |
| | (c) | Water-soluble | MTG | 21.6 | 21.6 | 21.6 | 21.6 | — | 21.6 | 21.6 | 26.6 | 11.6 | 5 |
| | | organic solvent | DPMA | — | — | — | — | 21.6 | — | — | — | — | — |
| | (d) | Photopolymerization | DAROCURE TPO | 8 | 8 | 8 | 8 | 8 | 8 | 8 | 8 | 8 | 8 |
| | | initiator | | | | | | | | | | | |
| | (e) | Surface conditioner | TEGO-Rad2100 | 0.1 | 0.1 | 0.1 | 0.1 | 0.1 | 0.1 | 0.1 | 0.1 | 0.1 | 0.1 |
| | (f) | Storage stabilizer | H-TEMPO | 0.3 | 0.3 | 0.3 | 0.3 | 0.3 | 0.3 | 0.3 | 0.3 | 0.3 | 0.3 |

| | | | | | | | | | | | |
|---|---|---|---|---|---|---|---|---|---|---|---|
| Evaluation | Viscosity (mPa · s) | ∘ | ∘ | ∘ | ∘ | ∘ | ∘ | ∘ | ∘ | ∘ | ∘ |
| | Solubility in water | ∘ | ∘ | ∘ | ∘ | ∘ | ∘ | ∘ | ∘ | Δ | ∘ |
| | Oily exudation | ∘ | ∘ | ∘ | ∘ | ∘ | ∘ | ∘ | ∘ | ∘ | ∘ |
| | Self-standing ability | ∘ | ∘ | ∘ | ∘ | ∘ | ∘ | ∘ | Δ | ∘ | ∘ |

| | | | | | | | | | Comparative |
|---|---|---|---|---|---|---|---|---|---|
| | | | | Example | | | | | Example |
| Composition for support material | | | | S11 | S12 | S13 | S14 | S15 | s1 |
| Proportion | (a) | Water-soluble | HEAA | — | — | — | — | — | — |
| (parts by | | ethylenically | ACMO | 30 | 40 | 21 | 25 | 25 | 15* |
| weight) | | unsaturated | DMAA | — | — | — | — | — | — |
| | | monomer | | | | | | | |
| | (b) | Polyalkylene glycol | PPG-400 | — | — | — | — | — | — |
| | | containing oxyethylene | PPG-1000 | 26.6 | 20 | 49 | 45 | 33 | 45 |
| | | group and/or | PEG-400 | — | — | — | — | — | — |
| | | oxypropylene group | PEG-1000 | — | — | — | — | — | — |
| | (c) | Water-soluble | MTG | 35 | 31.6 | 21.6 | 24.6 | 21.6 | 31.6 |
| | | organic solvent | DPMA | — | — | — | — | — | — |
| | (d) | Photopolymerization | DAROCURE TPO | 8 | 8 | 8 | 5 | 20 | 8 |
| | | initiator | | | | | | | |
| | (e) | Surface conditioner | TEGO-Rad2100 | 0.1 | 0.1 | 0.1 | 0.1 | 0.1 | 0.1 |
| | (f) | Storage stabilizer | H-TEMPO | 0.3 | 0.3 | 0.3 | 0.3 | 0.3 | 0.3 |

| | | | | | | | |
|---|---|---|---|---|---|---|---|
| Evaluation | Viscosity (mPa · s) | ∘ | ∘ | ∘ | ∘ | ∘ | ∘ |
| | Solubility in water | ∘ | Δ | ∘ | ∘ | ∘ | ∘ |
| | Oily exudation | Δ | ∘ | Δ | ∘ | ∘ | ∘ |
| | Self-standing ability | ∘ | ∘ | Δ | ∘ | ∘ | x |

*means that the value is deviated from the range regulated in the present invention.

HEAA: N-hydroxyethyl acrylamide [HEAA (ethylenic double bond/1 molecule: 1) manufactured by KJ Chemicals Corporation]

ACMO: Acryloyl morpholine [ACMO (ethylenic double bond/1 molecule: 1) manufactured by KJ Chemicals Corporation]

DMAA: N,N′-Dimethyl acrylamide [DMAA (ethylenic double bond/1 molecule: 1) manufactured by KJ Chemicals Corporation]

PPG-400: Polypropylene glycol [UNIOL D400 (molecular weight: 400) manufactured by NOF CORPORATION]

PPG-1000: Polypropylene glycol [UNIOL D1000 (molecular weight: 1000) manufactured by NOF CORPORATION]

PEG-400: Polyethylene glycol [PEG #400 (molecular weight: 400) manufactured by NOF CORPORATION]

PEG-1000: Polyethylene glycol [PEG #1000 (molecular weight: 1000) manufactured by NOF CORPORATION]

MTG: Triethylene glycol monomethyl ether [MTG manufactured by NIPPON NYUKAZAI CO., LTD.]

DPMA: Dipropylene glycol monomethyl ether acetate [DAWANOL DPMA manufactured by The Dow Chemical Company]

DAROCURE TPO: 2,4,6-Trimethylbenzoyl-diphenyl-phosphine oxide [DAROCURE TPO manufactured by BASF]

TEGO-Rad 2100: Silicon acrylate with polydimethylsiloxane structure [TEGO-Rad 2100 manufactured by Evonik Degussa Japan Co., Ltd.]

H-TEMPO: 4-Hydroxy-2,2,6,6-tetramethylpiperidine-N-oxyl [HYDROXY-TEMPO manufactured by Evonik Degussa Japan Co., Ltd.]

(Measurement of Viscosity)

The viscosity of each composition for support material was measured using a R100 type viscometer (manufactured by TOKI SANGYO CO., LTD.) under conditions of 25° C. and a cone rotation number of 5 rpm and was evaluated according to the following criteria. The evaluation results are shown in Table 2.

∘: Viscosity ≤70 mPa's

x: Viscosity >70 mPa's

(Solubility in Water)

In an aluminum cup having a diameter of 50 mm, 2.0 g of each composition for support material was sampled. Next, the composition for support material was irradiated with ultraviolet light and cured using an ultraviolet LED (NCCU 001E manufactured by NICHIA CORPORATION) as an irradiation unit so that the total irradiation light quantity was 500 mJ/cm² to obtain a support material. Thereafter, the support material was released from the aluminum cup. Subsequently, the support material was immersed in 500 ml of ion exchanged water contained in a beaker. The support material was visually observed every 10 minutes, the time required (hereinafter referred to as the time for dissolution in water) from the start of immersion to the complete dissolution or elimination of the original shape was measured, and the solubility was evaluated according to the following criteria. The evaluation results are shown in Table 2.

∘: Time for dissolution in water ≤1 hour

Δ: 1 Hour <time for dissolution in water <1.5 hours

x: Time for dissolution in water ≥1.5 hours

(Evaluation on Oily Exudation)

On an aluminum foil of 100 mm×100 mm, 1.0 g of each composition for support material was sampled. Next, the composition for support material was irradiated with ultraviolet light and cured using an ultraviolet LED (NCCU 001E manufactured by NICHIA CORPORATION) as an irradiation unit so that the total irradiation light quantity was 500 mJ/cm² to obtain a support material. Incidentally, the support material is in a solid state at this time point. This support material was left for 2 hours, and the presence or absence of exudation of the support material in an oil form on the surface was visually observed and evaluated according to the following criteria. The evaluation results are shown in Table 2.

∘: Oily exudation was not observed at all.

Δ: Oily exudation was slightly observed.

x: Oily exudation was remarkably observed.

(Evaluation on Self-Standing Ability)

The glass plate (trade name “GLASS PLATE” manufactured by AS ONE Corporation, 200 mm×200 mm×5 mm in thickness) used for the evaluation is a rectangle in plan view. Spacers having a thickness of 1 mm were disposed on the four sides of the upper surface of the glass plate to form a square region of 10 cm×10 cm. After each composition for support material was added in the region, another glass plate was superimposed thereon. Thereafter, the composition for support material was irradiated with ultraviolet light and cured using an ultraviolet LED (NCCU 001E manufactured by NICHIA CORPORATION) as an irradiation unit so that the total irradiation light quantity was 500 mJ/cm² to obtain a support material. Thereafter, the support material was released from the glass plate and cut into a shape of 10 mm long and 10 mm wide using a cutter to obtain a test piece. Then, 10 pieces of the test pieces were superimposed one on another to obtain a test piece group having a height of 10 mm. The test piece group was placed in an oven set at 30° C. in a state of being loaded with a weight of 100 g from the top and left for 1 hour. Thereafter, the shape of the test piece was observed, and the self-standing ability was evaluated according to the following criteria. The evaluation results are shown in Table 2.

∘: Shape was not changed.

Δ: Shape was slightly changed and weight was in inclined state.

x: Shape was remarkably changed.

As can be seen from the results in Table 2, the compositions for support material of Examples S1 to S15 satisfying all the requirements of the present invention had a viscosity suitable for discharging from the inkjet head. In addition, the support materials obtained by photocuring the compositions for support material of Examples S1 to S15 exhibited high solubility in water and suppressed oily exudation. Furthermore, the support materials obtained by photocuring the compositions for support material of S1 to S15 exhibited sufficient self-standing ability.

Furthermore, the support materials obtained from the compositions for support material of Examples S1 to S8, S10, S11, and S13 to S15 in which the content of the water-soluble monofunctional ethylenically unsaturated monomer (a) was 45 parts by weight or less and the content of the polyalkylene glycol (b) containing an oxyethylene group and/or an oxypropylene group was 25 parts by weight or more exhibited higher solubility in water. The support materials obtained from the compositions for support material of Examples S1 to S10, S14, and S15 in which the content of polyalkylene glycol (b) having an oxyethylene group and/or an oxypropylene group was 45 parts by weight or less and the content of the water-soluble organic solvent (c) was 30 parts by weight or less exhibited more suppressed oily exudation. The support materials obtained from the compositions for support material of Examples S1 to S7, S9 to S12, S14, and S15 in which the content of the water-soluble monofunctional ethylenically unsaturated monomer (a) was 25 parts by weight or more exhibited more sufficient self-standing ability.

<Optically Shaped Article>

(Evaluation on Dimensional Accuracy of Optically Shaped Article)

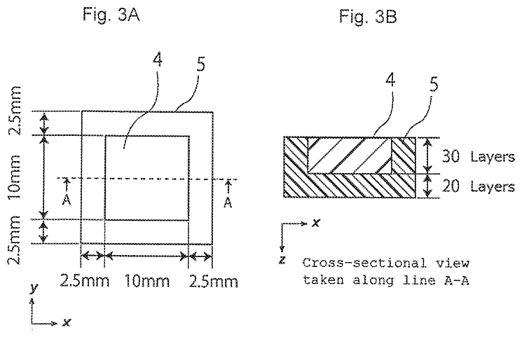

A cured product was prepared using an optical shaping ink set prepared by combining each composition for model material shown in Table 1 and each composition for support material shown in Table 2. The shape and intended dimensions of the cured product are illustrated in FIGS. 3(a) and 3(b). Incidentally, the step of discharging each composition for model material and each composition for support material from the inkjet head was performed so that the resolution was 600×600 dpi and the thickness of one layer of the composition layer was about 13 to 14 μm. In addition, the step of respectively photocuring each composition for model material and each composition for support material was performed using an LED light source which had a wavelength of 385 nm and was installed behind the inkjet head with respect to the scanning direction under the conditions of an illuminance of 250 mW/cm² and an integrated light quantity of 300 mJ/cm² per one layer of the composition layer. Next, the support material was removed by immersing the cured product in ion exchanged water, thereby obtaining an optically shaped article. Thereafter, the obtained optically shaped article was left to still stand in a desiccator for 24 hours to be sufficiently dried. The optically shaped article was produced by five pieces for each through the steps described above. The dimensions of the optically shaped articles after drying in the x direction and y direction in FIG. 3(a) were measured using a caliper, and the rate of change from the intended dimension was calculated. The dimensional accuracy was evaluated according to the following criteria using the average value of the rate of change in dimension in each optically shaped article. The evaluation results are shown in Table 3.

∘: Average rate of change in dimension is less than ±1.0%

x: Average rate of change in dimension is ±1.0% or more

TABLE 3

| Evaluation on | | Composition for model material | | | | | |
|---|---|---|---|---|---|---|---|
| dimensional accuracy | | M1 | M2 | M3 | M4 | m1 | m2 |
| Composition | S1 | ∘ | ∘ | ∘ | ∘ | x | x |
| for support | S2 | ∘ | ∘ | ∘ | ∘ | x | x |
| material | S3 | ∘ | ∘ | ∘ | ∘ | x | x |
| | S4 | ∘ | ∘ | ∘ | ∘ | x | x |
| | S5 | ∘ | ∘ | ∘ | ∘ | x | x |
| | S6 | ∘ | ∘ | ∘ | ∘ | x | x |
| | S7 | ∘ | ∘ | ∘ | ∘ | x | x |
| | S8 | ∘ | ∘ | ∘ | ∘ | x | x |
| | S9 | ∘ | ∘ | ∘ | ∘ | x | x |
| | S10 | ∘ | ∘ | ∘ | ∘ | x | x |
| | S11 | ∘ | ∘ | ∘ | ∘ | x | x |
| | S12 | ∘ | ∘ | ∘ | ∘ | x | x |
| | 313 | ∘ | ∘ | ∘ | ∘ | x | x |
| | S14 | ∘ | ∘ | ∘ | ∘ | x | x |
| | S15 | ∘ | ∘ | ∘ | ∘ | x | x |
| | s1 | x | x | x | x | x | x |

As can be seen from the results in Table 3, it was possible to obtain optically shaped articles having good dimensional accuracy by using the optical shaping ink sets comprising the compositions for model material of Examples M1 to M4 satisfying all the requirements of the present invention with the compositions for support material of S1 to S15 satisfying all the requirements of the present invention in combination.

### INDUSTRIAL APPLICABILITY

The optical shaping ink set of the present invention can be suitably used when an optically shaped article having good dimensional accuracy is produced by inkjet optical shaping method.

### DESCRIPTION OF REFERENCE SIGNS

1: Three-dimensional shaping apparatus
2: Inkjet head module
3: Shaping table
4: Model material
5: Support material
6: Cured product
7: Vessel
8: Solvent
21: Inkjet head for model material
22: Inkjet head for support material
23: Roller
24: Light source

1. An optical shaping ink set, which is used in an inkjet optical shaping method, comprising a composition for model material used for shaping a model material in combination with a composition for support material used for shaping a support material,
wherein
the composition for model material contains, with respect to 100 parts by weight of the total amount of the composition for model material,
a monofunctional ethylenically unsaturated monomer (A) at 50 to 90 parts by weight,
a polyfunctional ethylenically unsaturated monomer (B) which does not contain a urethane group at 3 to 25 parts by weight,
a urethane group-containing ethylenically unsaturated monomer (C) at 5 to 35 parts by weight, and
a photopolymerization initiator (D) at 0.1 to 10 parts by weight, and
the composition for support material contains, with respect to 100 parts by weight of the total amount of the composition for support material,
a water-soluble monofunctional ethylenically unsaturated monomer (a) at 20 to 50 parts by weight,
a polyalkylene glycol (b) containing an oxyethylene group and/or an oxypropylene group at 20 to 49 parts by weight,
a water-soluble organic solvent (c) at 35 parts by weight or less, and
a photopolymerization initiator (d), and
wherein the water-soluble monofunctional ethylenically unsaturated monomer (a) consists of one or two or more selected from the group consisting of hydroxyl group-containing (meth)acrylates having 2 to 15 carbon atoms, alkylene oxide adduct-containing (meth)acrylates having an Mn of 200 to 1,000, (meth)acrylamide derivatives having 3 to 15 carbon atoms, and (meth)acryloyl morpholine.

2. The optical shaping ink set according to claim 1, wherein the composition for model material has a weighted average value of an SP value of 9.0 to 10.3.

3. The optical shaping ink set according to claim 1, wherein a content of a water-soluble component in the composition for model material is 10 parts by weight or less with respect to 100 parts by weight of the total amount of the composition for model material.

4. The optical shaping ink set according to claim 1, wherein a water-swelling rate of a model material obtained by photocuring the composition for model material is 1% by weight or less.

5. The optical shaping ink set according to claim 1, wherein a glass transition point of a model material obtained by photocuring the composition for model material is 50° C. to 120° C.

6. The optical shaping ink set according to claim 1, wherein a content of the water-soluble monofunctional ethylenically unsaturated monomer (a) in the composition for support material is 25 to 45 parts by weight with respect to 100 parts by weight of the total amount of the composition for support material.

7. The optical shaping ink set according to claim 1, wherein a content of the polyalkylene glycol (b) in the composition for support material is 25 to 45 parts by weight with respect to 100 parts by weight of the total amount of the composition for support material.

8. The optical shaping ink set according to claim 1, wherein a content of the water-soluble organic solvent (c) in the composition for support material is 5 parts by weight or more with respect to 100 parts by weight of the total amount of the composition for support material.

9. The optical shaping ink set according to claim 1, wherein a content of the photopolymerization initiator (d) in the composition for support material is 1 to 25 parts by weight with respect to 100 parts by weight of the total amount of the composition for support material.

10. The optical shaping ink set according to claim 1, wherein the composition for support material further contains a storage stabilizer (e) at 0.05 to 3.0 parts by weight with respect to 100 parts by weight of the total amount of the composition for support material.

11. An optically shaped article shaped by an inkjet optical shaping method using the optical shaping ink set according to claim 1.

12. A method for producing an optically shaped article by an inkjet optical shaping method using the optical shaping ink set according to claim 1, the method comprising:
a step (I) of photocuring the composition for model material to obtain a model material and, at the same time, photocuring the composition for support material to obtain a support material; and
a step (II) of removing the support material.

13. The method for producing an optically shaped article according to claim 12, wherein the composition for model material and the composition for support material are photocured using an ultraviolet LED in the step (I).

14. The optical shaping ink set according to claim 2, wherein a content of a water-soluble component in the composition for model material is 10 parts by weight or less with respect to 100 parts by weight of the total amount of the composition for model material.
